(19) United States
(12) Patent Application Publication
(10) Pub. No.: US 2006/0263526 A1
(43) Pub. Date: Nov. 23, 2006

(54) Method of protectively coating a workpiece, and product which is produced thereby

(75) Inventor: Robert Eastman II, Flint, MI (US)

Correspondence Address: CARRIER BLACKMAN AND ASSOCIATES, 24101 NOVI ROAD, SUITE 100, NOVI, MI, 48375, US

(73) Assignee: Eastman Holding Co., Flushing, MI (US)

(21) Appl. No.: 11/435,356

(22) Filed: May 16, 2006

Related U.S. Application Data
(60) Provisional application No. 60/683,399, filed on May 20, 2005.

(51) Int. Cl. B05D 3/00; B05D 3/02; B05D 1/36

(52) U.S. Cl. 427/299; 427/372.2; 427/402

(57) ABSTRACT

A method of applying a decorative undercoat and a sound-dampening elastomeric outer coating onto a workpiece may be used on a workpiece that is expected to movably contact another adjacent component when used as part of an assembly. The workpiece may be roughened through sanding by machine or by hand, and then may be sprayed with a base paint coat. The workpiece is then placed in a baking chamber where the base coat is allowed to partially cure so that a subsequent coating will adhere thereto. The workpiece is then coated with an image bearing film, and is then again heated to cure the decorative image-bearing film. Then, the workpiece is sprayed with an elastomeric coating over the dried decorative film and allowed to final cure in a baking chamber.

### BACKGROUND OF THE INVENTION

1. Field of the Invention

The present invention relates to a method of applying a decorative and protective coating to a plastic or metal workpiece. More particularly, the present invention relates to a process used to apply both a decorative undercoat and a sound-dampening elastomeric outer coating to a plastic or metal workpiece, and to coated articles which are products of the described method. The coated workpiece may, optionally, be a component that is expected to movably contact another adjacent component when used as part of an assembly, and the coating hereof tends to reduce or eliminate sounds, which would otherwise be made, when these components come into contact with one another.

2. Description of the Background Art

Examples of some issued patents relating to similar coating technologies include U.S. Pat. No. 5,765,845, U.S. Pat. No. 4,346,782, U.S. Pat. No. 6,277,903, U.S. Pat. No. 6,726,957 B2, and Canadian Patent 2,304,539.

Canadian Patent 2,304,539 describes a sprayable coating having properties for absorbing or reducing noise, vibration and harshness. The coating described in this reference includes from 10-60% of flexible epoxy resin and 5-40% of a rigid epoxy resin formulation and a curing agent for the epoxy moieties. The reference describes a method of coating a workpiece to reduce the impact of noise vibration and harshness on the workpiece or users of the workpiece. The process comprises spraying the above defined composition onto a workpiece and then curing the resin between a temperature of 0-190° C. The method is applied by spraying and can be applied to irregularly-shaped objects. The described coating provides noise and vibration suppression, corrosion resistance, and abrasion resistance.

U.S. Pat. No. 5,765,845 describes a method of coating workpieces to apply both decorative and protective coating layers thereto, and to coated workpieces which are products of the described method. Workpieces which have been coated by the described method minimize scrubbing noises during articulating contact. The described method includes preparing an object to present at least one mechanically adherable stiff surface, thermally spraying a top coating onto the object, where the top coating includes a self-lubricating metal, a ceramic material, a metal alloy, or a compliant metal, and placing the coating interface into service to subject it to repeating articulating swiveling contact that adheres the coating to the underlying surface.

The process involves applying a wear resistant and noise suppressing coating to one or both interfacing surfaces by preparing the interfacing surface by cleaning and roughening of such surface to removing stamping oils and residual grease in order to create an adherable stiff surface. The interface surface is washed then blasted with an abrasive grit, rough machining or equivalent roughening technique. After the cleaning and roughening step the surface is thermally sprayed to provide a top coating which consists of one of the following (i) a self lubricating metal or metal alloy, (ii) a compliant metal. The thermal spraying is carried out by wire spraying where the metals of the coating are introduced as wire feed stock which are used as consumable electrodes in a gun. One essential step must take place subsequent to the coating steps and that is placing the coated interface into service where it is subjected to repeated articulating swiveling contact that functions to adhere the coating to the supporting interface.

U.S. Pat. No. 4,346,782 describes a method of producing a vibration damping and sound absorbing coating on a rigid workpiece is provided in which a first coating of a viscoelastic material having after gelling a modulus of elasticity is sprayed onto the workpiece, and a second coating of a viscoelastic material is sprayed on the workpiece over the first coating. A structure-borne vibration and sound damping effect, and at the same time corrosion and abrasion resistance are provided by the coating on a rigid workpiece in which successively two coating materials with different moduli of elasticity are applied to the workpiece.

U.S. Pat. No. 6,277,903 discloses a sprayable coating having noise vibration and harshness reduction or absorption properties. The composition comprises about 10 to 60% of the flexible epoxy resin from about 5 to 40% by weight of a rigid epoxy resin formulation, and having a curing agent for the epoxy moieties from a temperature of about 60° C. to about 190° C. Another embodiment of the invention is a method of coating a workpiece to reduce the impact of noise vibration and harshness on the workpiece or users of the workpiece which process comprises spraying the above defined composition on to a workpiece and curing the resin on such workpiece. The coatings of the invention provide for noise and vibration attenuation, corrosion resistance, impact resistance and abrasion resistance. The process also allows for coating irregular shaped objects in a cost effective way and allows complete surface contact of the coating on the workpiece.

U.S. Pat. No. 6,726,957 discloses a flexible sound-dampening protective polymer coating composition, and method of using the composition. The coating is based on silicon/epoxy chemistry combined with ground silicone and catalyzed with organometallic compounds. The method of using the composition on a workpiece includes steps of cleaning the workpiece surface, choosing a coating composition, applying the coating to the workpiece surface by a spray process, and heating the workpiece to at least 400° F. for at least 20 minutes. The method of applying the coating composition to the workpiece surface of the claim wherein the workpiece surface is a surface of a muffler. The method can also include applying the coating composition to the workpiece surface wherein the method of cleaning the workpiece is chosen from an alkali wash, a chemical pretreatment and a sand blast. The spray process is chosen from a conventional spray process, an airless spray process, an air assisted spray process and an electrostatic spray process.

Although the known devices have some utility for their intended purposes, a need still exists in the art for an improved sound-dampening coating and method, that not only provides sound-dampening and corrosion protection, but also is applied in a method that has a decorative element and which can be applied to workpieces in a cost-efficient manner. In particular, there is a need for an improved method that will overcome difficulties encountered with the known art such as not providing for a decorative undercoat for a workpiece along with the conventional sound-dampening outer coating to workpieces that are expected to movably contact one another when used as part of an assembly.

### SUMMARY OF THE INVENTION

Accordingly, it is an object of the present invention to provide a method for applying a decorative undercoat and a sound-dampening outer coating to plastic or metal objects that are expected to movably contact another component when used as part of an assembly. It is another object of the present invention to provide a coated product that is a product of the described method.

In a first coating step according to the invention, an undercoat is applied which is decorative in nature. The undercoat is baked in place on the workpiece, and then a thin layer of a transparent, resilient outer coating is applied over the decorative undercoat.

The resilient outer coating may be a plastisol including a vinyl monomer, or alternatively, may be a sprayable liquid composition including a straight-chain or linetype polyester, an impregnant and an elasticizer. After the resilient outer coating has been applied, the workpiece is then placed in the heat tunnel or oven at 50-60° C. for about 30 minutes or until it has completely dried.

As a result of the described process, a visually appealing part is produced which can be placed in contact with a similarly treated part, and relative movement of these two parts will then be either silent, or will only make a minimal noise. Squeaking and similar noises will be minimized or eliminated. Where a ferrous metal workpiece is treated with this process, the workpiece will also be rust-resistant.

This process is appropriate for components of tree stands, ladder stands, and tree seats. The process may also be applied more generally to bows and other hunting equipment, and also to guns and related weaponry for military applications.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a perspective view of a metal workpiece being dipped into an acidic cleaning bath as an optional first step of an illustrative embodiment of an inventive process hereof;

FIG. 2 is a perspective view of a cleaned metal workpiece being hand sanded as another optional step in the illustrative process hereof;

FIG. 3 is a perspective view of a base coat being sprayed on to a cleaned and sanded metal workpiece as part of the illustrative process hereof;

FIG. 4 is a perspective view of a number of metal workpieces in a baking chamber where the base coat is being partially dried as part of the illustrative process hereof;

FIG. 5 is a perspective view of a water bath with an image-bearing film floating thereon as part of the illustrative process hereof;

FIG. 6 is a perspective view of a metal workpiece being immersed in the water bath of FIG. 5 to apply the image-bearing film thereto as part of the illustrative process hereof;

FIG. 7 is a perspective view of the decoratively coated metal workpiece of FIG. 6 being rinsed by spray nozzles as part of the illustrative process hereof;

FIG. 8 is a perspective view of a number of metal workpieces in a baking chamber where the decorative film is being dried thereon as part of the illustrative process hereof;

FIG. 9 is a perspective view of the metal workpiece of FIG. 8 having an uncured elastomeric outer coating spray-applied over the dried decorative film as part of the illustrative process hereof; and

FIG. 10 is a front plan view of a baking chamber in which the elastomeric outer coating is being cured in place over the decorative film undercoat on a number of metal workpieces suspended on hangers from support racks.

FIG. 10 is a schematic flow chart showing steps in an illustrative method according to the present invention.

### DETAILED DESCRIPTION

It should be understood that only structures considered necessary for clarifying the present invention are described herein. Other conventional structures, and those of ancillary and auxiliary components of the system, are assumed to be known and understood by those skilled in the art.

A method of coating metal or plastic workpieces, according to an illustrative embodiment of the invention, includes the following steps in the sequence set forth. Some of these steps are optional, and may be used or omitted as a user desires.

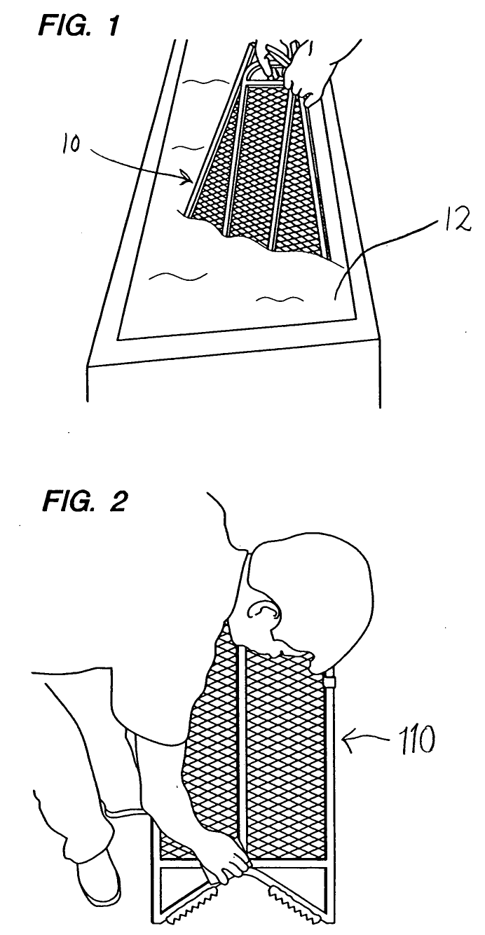

Referring now to FIG. 1, a metal workpiece 10, where used, may be pretreated by immersion in an acid bath 12, in order to remove any rust, oil or residue that may be on the workpiece as a result of machining, and to prepare the surface to be coated. This step is optional.

The metal workpiece 10 is then rinsed, dried and the external surface of the workpiece is hand or machine sanded in order to remove rough spots and create a smooth surface, such that subsequent coatings will adhere well to the surface of the metal workpiece. An alternately shaped workpiece 110 is shown in FIG. 2, with an operator sanding the surface thereof. (Plastic workpieces do not require this pretreatment). This sanding step is also optional.

After the sanding step has been completed, the workpiece 10 may be mounted from a support rack 11 suspended from a conveyor apparatus 15 (FIG. 4), which may then assist in automated movement of the workpiece from one treatment station to the next station in carrying out the method hereof. Alternatively, the sanding step may be omitted and/or the entire sequence may be automated.

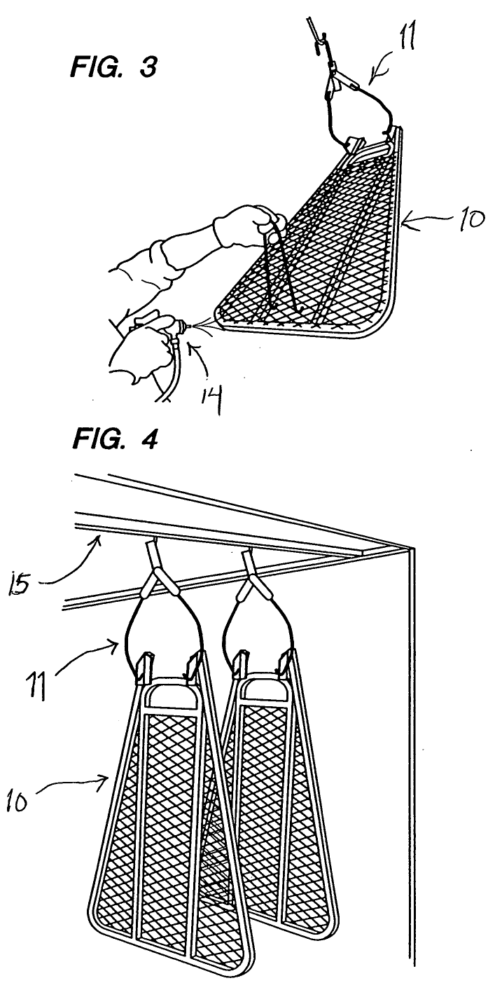

With the exception of ABS plastic, all other metal and plastic workpieces require a base paint coat, prior to the image film dipping. A sprayer 14 is shown applying a base coat to the workpiece 10 in FIG. 3. The base paint coat can be applied to the plastic or sanded metal workpiece either by dipping, spraying or brushing. For steel, this base paint coat may be an amino paint and for aluminum, this base coat may be a nitryl paint. Other suitable coating materials may alternately be used. Application of the base paint coat is shown at step 20 in the schematic flow chart of FIG. 11.

Following this application of the base paint coat, the workpiece is baked in a heat tunnel or oven for 40 minutes at 65-75° C. in order to partially dry the base paint coat. This baking step is illustrated in FIG. 4 of the drawings. The base paint coat is left slightly sticky to promote subsequent adhesion of the image-bearing film thereto. Curing of the base paint coat is shown at step 22 in the schematic flow chart of FIG. 11.

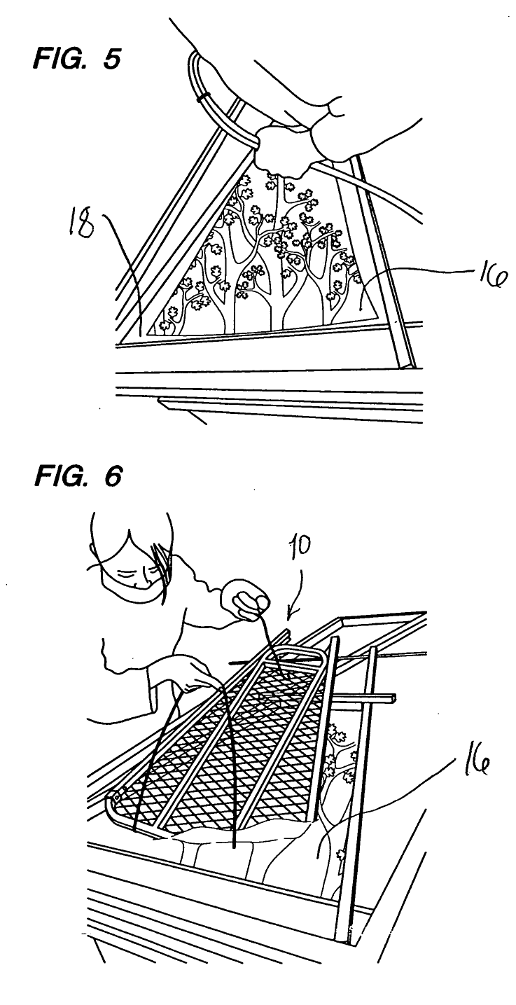

An image-bearing film 16 (FIG. 5), which may be made of polyvinyl acetate (PVA) film material, is laid on the surface of a water bath 18, maintained at about 25° C. The metal or plastic workpiece is then dipped into the water bath 18, as shown in FIG. 6, with the image-bearing film floating on the surface of the water. The image-bearing film 16 then wraps around the workpiece 10 and becomes attached to the exterior surface of the workpiece, supplying the surface of the workpiece with the exact pattern from the film. Application of the image-bearing film to the workpiece is shown at step 24 in the schematic flow chart of FIG. 11.

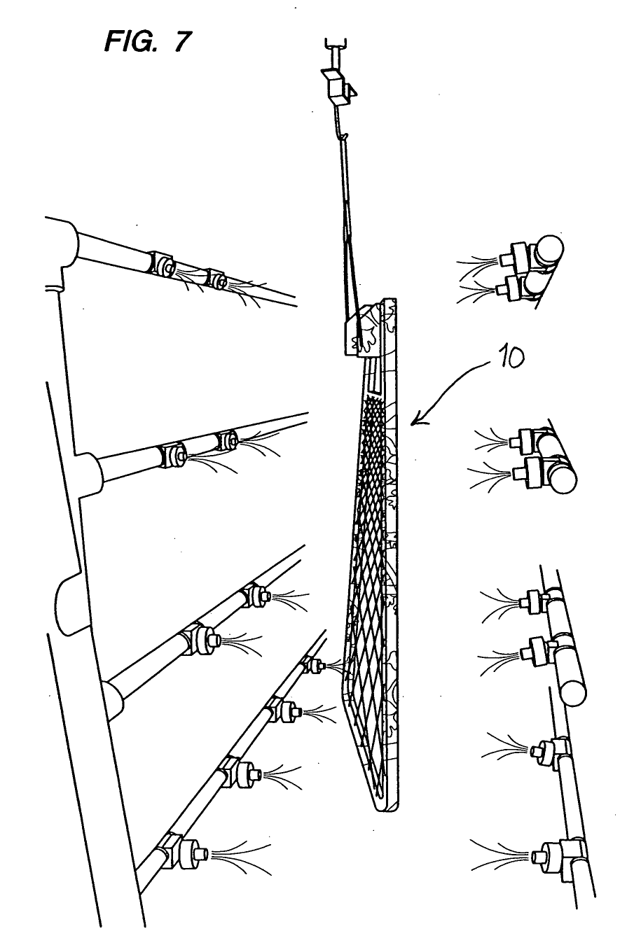

The workpiece 10 is then removed from the water bath 18, and rinsed to remove any excess residue. FIG. 7 illustrates the workpiece 10, with the decorative film affixed thereto, being rinsed in a rinsing booth.

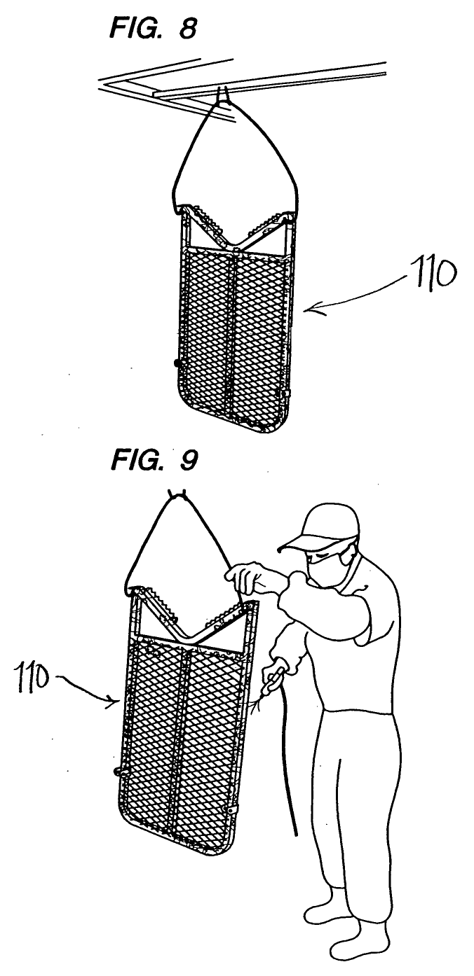

The workpiece 10 or 110 is then placed in the heat tunnel or oven for 30 minutes at 50-60° C. in order to completely dry the workpiece. FIG. 8 shows a workpiece 110 being dried in a heat tunnel. Curing the image-bearing film on the workpiece is shown as step 26 in the schematic flow chart of FIG. 11.

After the applied film 16 has been baked on to the workpiece 10 or 110, a clear, uncured elastomeric material is evenly sprayed onto the dried workpiece. The spray application of the uncured outer elastomeric material to the decoratively workpiece 110 is shown in FIG. 9. The uncured material used for the outer layer is somewhat viscous when applied, and therefore, may be applied in a relatively thick layer. The outer layer may be applied, for example, in a thickness ranging from 0.10 mm-2 mm. Application of the outer coating over the image-bearing film is shown as step 28 in the schematic flow chart of FIG. 11.

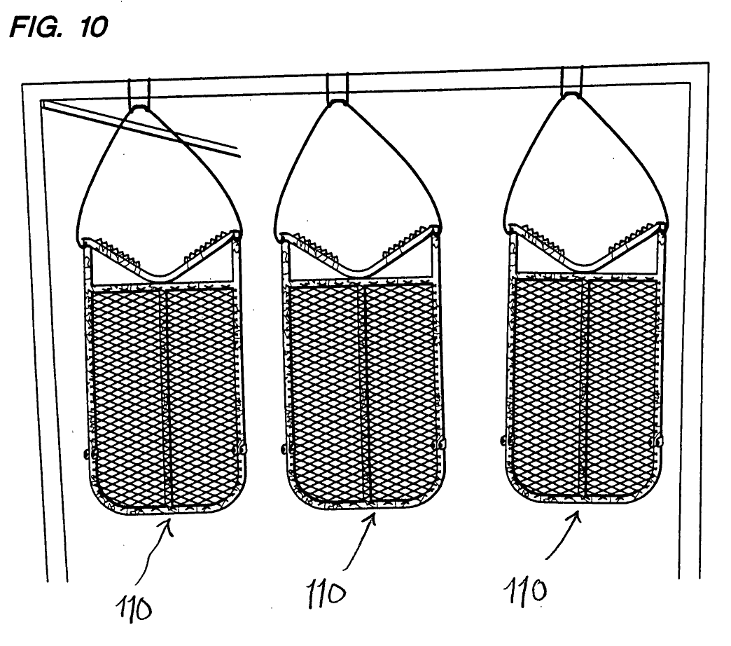

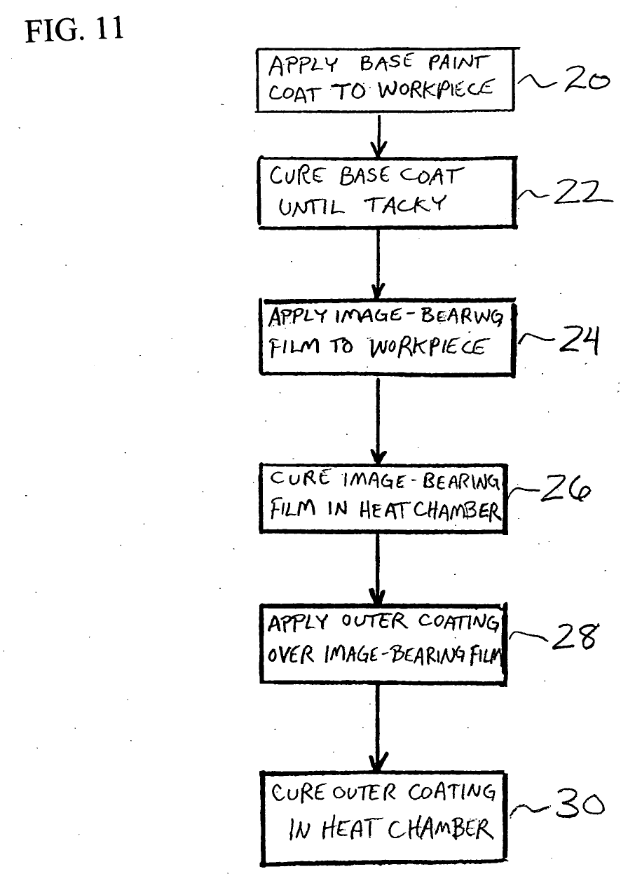

After the outer coating has been sprayed on to the workpiece 110, it is then heat-cured to form a flexible resilient outer coating over the decorative film, in order to protect the workpiece, and also to reduce or eliminate possible noises which could otherwise be created when two adjacent touching metal workpieces move relative to one another. The final baking step is illustrated on three adjacent workpieces 110 in FIG. 10, and is also shown as step 30 in the schematic flow chart of FIG. 11.

Although the present invention has been described herein with respect to a number of specific illustrative embodiments, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention.

Having, thus, described the invention, what is claimed is:

1. A method of coating a workpiece comprising the steps of:
(a) optionally, immersing the workpiece in an acid bath for a length of time sufficient to clean the workpiece;
(b) optionally, sanding a surface of the workpiece;
(c) optionally, applying a base coat to an exterior surface of the workpiece;
(d) optionally, heating the workpiece for a length of time sufficient to make the base coat sufficiently dry and sticky to promote subsequent adhesion of an image-bearing film thereto;
(e) applying an image-bearing film coating to the exterior surface of the workpiece;
(f) heating the workpiece with the decorative film thereon until the decorative film is substantially dried;
(g) applying an uncured elastomeric coating to the exterior of the workpiece over the dried decorative film to form an outer layer; and
(h) heating the workpiece to cure the outer layer in place over the decorative film.

2. The method of claim 1, wherein the decorative film comprises polyvinyl acetate.

3. The method of claim 1, wherein the workpiece is formed from a plastic material.

4. The method of claim 1, wherein the workpiece is made of metal.

5. The method of claim 1, wherein the outer layer is applied in a thickness ranging from 0.10 mm-2 mm.

6. A method of coating a workpiece, comprising the steps of:
a) optionally, immersing the workpiece in an acid bath for a length of time sufficient to clean the workpiece;
b) optionally, sanding a surface of the workpiece;
c) applying a base paint coat to an exterior surface of the workpiece;
d) heating the workpiece for a length of time sufficient to make the base paint coat partially dry and sufficiently sticky to promote subsequent adhesion of an image-bearing film thereto;
e) applying an image-bearing film coating to the exterior surface of the workpiece over the base paint coat;
f) heating the workpiece with the decorative film thereon until the decorative film is substantially dried;
g) applying an uncured elastomeric coating to the exterior of the workpiece over the dried decorative film to form an outer layer; and
h) heating the workpiece to cure the outer layer in place over the decorative film.

7. The method of claim 6, wherein the decorative film comprises polyvinyl acetate.

8. The method of claim 6, wherein the workpiece is formed from a plastic material.

9. The method of claim 6, wherein the workpiece is made of metal.

10. The method of claim 6, wherein the outer layer is applied in a thickness ranging from 0.10 mm-2 mm.

11. The method of claim 1, wherein the workpiece is suspended from a conveyor apparatus which conveys the workpiece from one treatment station to another while the method is being performed.

12. The method of claim 6, wherein the workpiece is suspended from a conveyor apparatus which conveys the workpiece from one treatment station to another while the method is being performed.

13. A coated article which is a product of the method of claim 1.

14. A coated article which is a product of the method of claim 6.
